(19) United States
(12) Patent Application Publication
(10) Pub. No.: US 2025/0084306 A1
(43) Pub. Date: Mar. 13, 2025

(54) QUANTUM DOT AND METHOD FOR PREPARING THE QUANTUM DOT

(71) Applicant: Samsung Display Co., Ltd., Yongin-si (KR)

(72) Inventors: JUNEHYUK JUNG, Yongin-si (KR); SUNGJAE KIM, Yongin-si (KR); Youngsik KIM, Yongin-si (KR); Bitna YOON, Yongin-si (KR); DONGHEE LEE, Yongin-si (KR); TAEKJOON LEE, Yongin-si (KR)

(21) Appl. No.: 18/774,800

(22) Filed: Jul. 16, 2024

(30) Foreign Application Priority Data
Sep. 11, 2023 (KR) 10-2023-0120700

(51) Int. Cl. C09K 11/62; C09K 11/02; C09K 11/56

(52) U.S. Cl. CPC C09K 11/621; C09K 11/02; C09K 11/565

(57) ABSTRACT

A method for preparing a quantum dot and a quantum dot are provided. The method for preparing a quantum dot includes supplying a first mixture including a first precursor containing gallium oleate, a second precursor containing indium oleate, and a third precursor containing a sulfur atom, forming a second mixture by adding a first solvent to the first mixture, and forming a fourth mixture including a core containing a copper atom, an indium atom, a gallium atom, and a sulfur atom by adding a third mixture containing copper to the second mixture.

### CROSS-REFERENCE TO RELATED APPLICATIONS

The present application claims priority to and the benefit of Korean Patent Application No. 10-2023-0120700, filed on Sep. 11, 2023, in the Korean Intellectual Property Office, the entire content of which is incorporated herein by reference.

### BACKGROUND

### 1. Field

Embodiments of the present disclosure relate to a quantum dot and a method for preparing the quantum dot, and for example, to a quantum dot having improved color reproductivity and light absorption properties, and a method for preparing the same.

### 2. Description of the Related Art

The development of various display devices used in multimedia apparatuses, such as televisions, mobile phones, tablets, navigation systems, and/or game consoles, is being conducted. In the display devices, so-called self-luminescence type or kind display elements with and causing emission materials containing organic compounds to emit light to thereby implement displays (e.g., of images) are used.

In addition, in order to improve color reproductivity of display devices, development of light-emitting elements using quantum dots as emission materials is being conducted or pursued, and improvements to the lifespan and emission efficiency of the light-emitting elements using quantum dots are desired or required.

### SUMMARY

Aspects of one or more embodiments of the present disclosure relate to a quantum dot having improved color reproductivity and light absorption properties by including a core containing copper, gallium, indium, and sulfur.

Aspects of one or more embodiments of the present disclosure also relates to a method for preparing a quantum dot having improved color reproductivity and light absorption properties by including a core containing copper, gallium, indium, and sulfur. Additional aspects will be set forth in part in the description which follows and, in part, will be apparent from the description, or may be learned by practice of the presented embodiments of the disclosure.

One or more embodiments of the present disclosure provides a method for preparing a quantum dot including: supplying a first mixture including a first precursor containing gallium oleate, a second precursor containing indium oleate, and a third precursor containing a sulfur atom; forming a second mixture by adding a first solvent to the first mixture; and forming a fourth mixture including a core containing a copper atom, an indium atom, a gallium atom, and a sulfur atom by adding a third mixture containing copper to the second mixture.

In one or more embodiments, the core may have a diameter of about 3 nm to about 6 nm.

In one or more embodiments, the first solvent may include at least one selected from among 1-octadecene and trioctylamine.

In one or more embodiments, the method may further include reacting the fourth mixture at a first temperature for about 5 minutes to about 15 minutes, and the first temperature may be about 250° C. to about 350° C.

In one or more embodiments, in the second mixture, a number of moles of the gallium atoms may be greater than a number of moles of the indium atoms.

In one or more embodiments, the method may further include forming a first shell around (e.g., covering) the core by reacting a fourth precursor containing zinc oleate and a fifth precursor containing a sulfur atom.

In one or more embodiments, in the quantum dot, a mass of gallium atoms may be about 5 wt % (e.g., weight % or mass %) to about 50 wt % with respect to a total mass of 100 wt % the quantum dot, and a mass ratio of the gallium atoms with respect to the mass of the quantum dot may be greater than a mass ratio of indium atoms with respect to the mass of the quantum dot in the quantum dot.

In one or more embodiments, the first solvent may include 1-octadecene and trioctylamine, and the method may include degassing the trioctylamine at about 120° C. before the forming of the first shell.

In one or more embodiments, the forming of the first shell may be performed at a second temperature for about 15 minutes to about 25 minutes, and the second temperature may be about 280° C. to about 350° C.

In one or more embodiments, a molar ratio of the fourth precursor to the fifth precursor may be about 1:1.

In one or more embodiments, in the forming of the first shell, the fourth precursor and the fifth precursor may each independently be provided in amount of about 0.4 mmol to about 1.6 mmol.

In one or more embodiments, the first shell has a thickness of about 0.5 nm to about 3 nm.

In one or more embodiments, the method may further include forming a second shell around (e.g., covering) the first shell by adding a first element precursor and a second element precursor to a first particle including the core and the first shell.

In one or more embodiments, the second shell may include at least one selected from among ZnSe, ZnS, ZnTe, ZnO, ZnMg, ZnMgSe, ZnMgS, ZnMgAl, GaSe, GaTe, GaP, GaAs, GaSb, InAs, InSb, AlP, AlAs, AlSb, MnS, MnSe, MgS, and MgSe.

In one or more embodiments, the second shell may have a thickness of about 0.5 nm to about 3 nm.

In one or more embodiments, a thickness of the second shell may be greater than a thickness of the first shell.

In one or more embodiments of the present disclosure, a quantum dot includes a core containing a copper atom, an indium atom, a gallium atom, and a sulfur atom, and a first shell around (e.g., covering) the core and containing a zinc atom, and a sulfur atom, and the core have a diameter of about 3 nm to about 6 nm.

In one or more embodiments, a mass of the gallium atoms may be about 5 wt % (e.g., weight % or mass %) to about 50 wt % with respect to a total mass of 100 wt % the quantum dot, and a mass ratio of the gallium atoms with respect to the mass of the quantum dot may be greater than a mass ratio of the indium atoms with respect to the mass of the quantum dot.

In one or more embodiments, the quantum dot may further include a second shell around (e.g., covering) the first shell and containing at least one selected from among ZnSe, ZnS, ZnTe, ZnO, ZnMg, ZnMgSe, ZnMgS, ZnMgAl, GaSe, GaTe, GaP, GaAs, GaSb, InAs, InSb, AlP, AlAs, AlSb, MnS, MnSe, MgS, and MgSe.

In one or more embodiments, a thickness of the second shell may be greater than a thickness of the first shell.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain principles of the present disclosure. In the drawings:

FIG. 1 is a perspective view of an electronic apparatus according to one or more embodiments of the present disclosure;

FIG. 2 is an exploded perspective view of an electronic apparatus according to one or more embodiments of the present disclosure;

FIG. 3 is a cross-sectional view of a display device taken along the line I-I′ in FIG. 1, according to one or more embodiments of the present disclosure;

FIG. 4 is a cross-sectional view of a light-emitting element according to one or more embodiments of the present disclosure;

FIG. 5 is a view schematically illustrating a structure of a quantum dot according to one or more embodiments of the present disclosure;

FIG. 6 is a view schematically illustrating a structure of a quantum dot according to one or more embodiments of the present disclosure;

FIG. 7 is a plan view illustrating a portion of a display device that is enlarged, according to one or more embodiments of the present disclosure;

FIG. 8 is a cross-sectional view of a display device taken along the line II-II′ of FIG. 7, according to one or more embodiments of the present disclosure;

FIG. 9 is a cross-sectional view of a display device taken along the line II-II′ of FIG. 7, according to one or more embodiments of the present disclosure;

FIG. 10 is a flow chart showing a method for preparing a quantum dot according to one or more embodiments of the present disclosure;

FIG. 11 shows absorbance and emission spectra of a quantum dot according to Example 1; and

FIG. 12 shows absorbance spectra of quantum dots according to Example 1 and Comparative Example 2.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

Hereinafter, example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

It will be understood that when an element, such as an area, layer, film, region or portion, is referred to as being “on,” “connected to,” or “bonded to” another element, it can be directly on, connected to, or bonded to the other element, or one or more intervening elements may be present. In addition, it will also be understood that when an element is referred to as being “between” two elements, it can be the only element between the two elements, or one or more intervening elements may also be present.

Unless otherwise noted, like reference numerals denote like elements throughout the attached drawings and the written description, and thus, duplicative descriptions thereof may not be provided. In addition, in the drawings, the thickness, the ratio, and the dimensions of elements may be exaggerated for an effective description of technical contents.

As used herein, the term “and/or” includes any and all combinations of one or more of the associated listed items.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

As used herein, the singular forms “a,” “an” and “the” are intended to include the plural forms as well, unless the context clearly indicates otherwise.

Spatially relative terms, such as “on,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be further understood that the terms “comprises,” “comprising,” “includes,” “including,” “have,” “having,” “contain,” and “containing,” when used in this specification, specify the presence of the stated features, integers, steps, operations, elements, and/or components, but do not preclude the presence or addition of one or more other features, integers, steps, operations, elements, components, and/or groups thereof.

Unless otherwise apparent from the disclosure, expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

As used herein, when an element is referred to as being “directly disposed,” on another element or layer, there are no intervening layers, films, regions, plates, and the like present between portions such as layers, films, regions, and plates and other portions. For example, two layers or two members that are “directly disposed” may mean that the two layers or two members are disposed without using an additional member therebetween.

As used herein, “Group” refers to a group of the IUPAC Periodic Table of Elements.

As used herein, “Group I” may include Group IA elements and Group IB elements. For example, the Group I element may be copper (Cu), but is not limited thereto.

As used herein, “Group II” may include Group IIA elements and Group IIB elements. For example, the Group II elements may be magnesium (Mg) or zinc (Zn), but are not limited thereto.

As used herein, “Group III” may include Group IIIA elements and Group IIIB elements. For example, the Group III elements may be aluminum (Al), indium (In), gallium (Ga), or titanium (Ti), but are not limited thereto.

As used herein, “Group V” may include Group VA elements and Group VB elements. For example, the Group V elements may be phosphorus (P), arsenic (As), or antimony (Sb), but are not limited thereto.

As used herein, “Group VI” may include Group VIA elements and Group VIB elements. For example, the Group VI elements may be oxygen (O), sulfur(S), selenium (Se) or tellurium (Te), but are not limited thereto.

As used herein, the terms “use,” “using,” and “used” may be considered synonymous with the terms “utilize,” “utilizing,” and “utilized,” respectively.

In the present disclosure, when particles are spherical, “diameter” indicates a particle diameter or an average particle diameter, and when the particles are non-spherical, the “diameter” indicates a major axis length or an average major axis length. The diameter of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

Unless otherwise defined, all terms (including technical and scientific terms) used herein have the same meaning as commonly understood by one of ordinary skill in the art to which the present disclosure pertains. Also, terms, such as those defined in commonly used dictionaries, should be interpreted as having a meaning that is consistent with their meaning in the context of the relevant art and/or the present specification, and should not be interpreted in an idealized or overly formal sense unless expressly so defined herein.

Hereinafter, a quantum dot according to one or more embodiments of the present disclosure, and a light-emitting element and a display device including the same will be described with reference to the accompanying drawings.

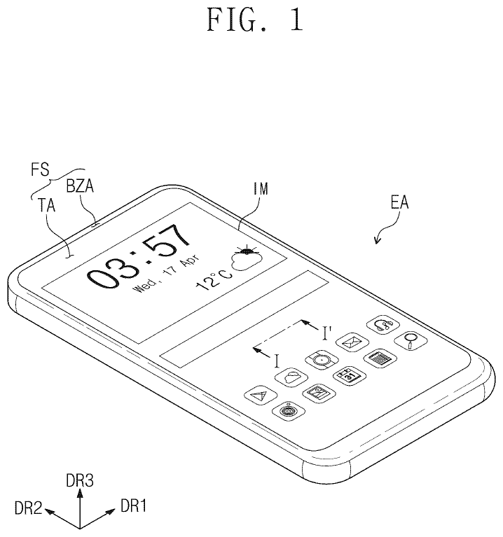

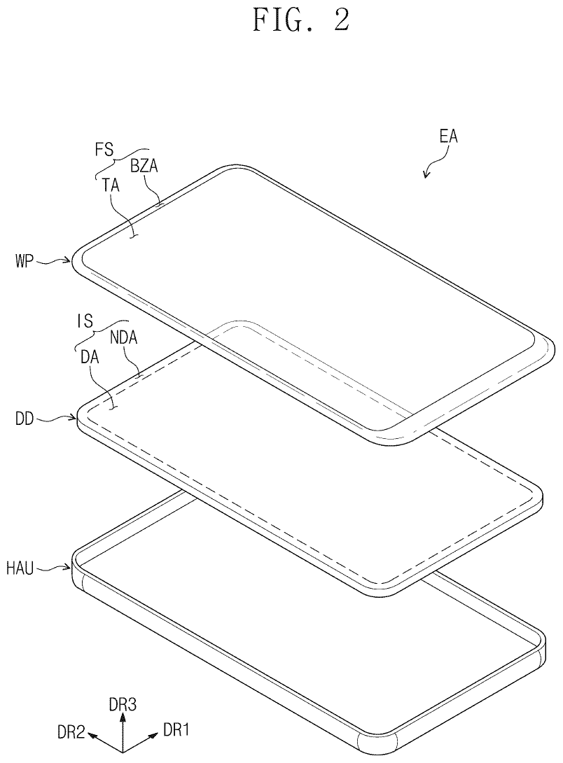

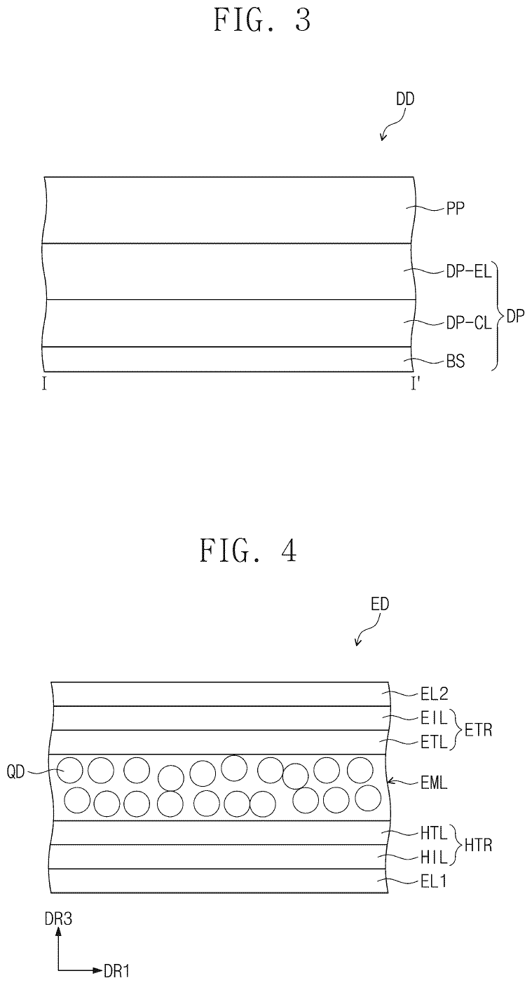

FIG. 1 is a perspective view illustrating an electronic apparatus EA according to one or more embodiments of the present disclosure. FIG. 2 is an exploded perspective view of the electronic apparatus EA according to one or more embodiments of the present disclosure. FIG. 3 is a cross-sectional view of a display device DD taken along the line I-I′ in FIG. 1, according to one or more embodiments of the present disclosure. FIG. 4 is a cross-sectional view of a light-emitting element ED according to one or more embodiments of the present disclosure.

In one or more embodiments, an electronic apparatus EA may be a large-sized electronic apparatus such as a television, a monitor, or an outdoor billboard. In one or more embodiments, the electronic apparatus EA may be a small- and medium-sized electronic apparatus such as a personal computer, a laptop computer, a personal digital assistant, a car navigation unit, a game console, a smartphone, a tablet, and/or a camera. These apparatuses are merely suggested as examples, and other electronic apparatuses may be employed as long as they do not depart from spirit and scope of the present disclosure. In FIG. 1, a smartphone is shown as an example of the electronic apparatus EA for ease of description.

The electronic apparatus EA may include a display device DD and a housing HAU. The display device DD may display an image IM through a display surface IS, and the user may view the image provided through a transmission region TA corresponding to a front surface FS of the electronic apparatus EA. The image IM may include a still image as well as a dynamic image. In FIG. 1, the front surface FS is illustrated to be parallel to a plane defined by a first direction DR1 and a second direction DR2 crossing the first direction DR1. However, this is shown as an example, and in one or more embodiments, the front surface FS of an electronic apparatus EA may have a curved shape.

A normal direction of the front surface FS (e.g., a direction perpendicular to the front surface FS) of the electronic apparatus EA, e.g., the normal direction may be a direction in which the image IM is displayed or may be a thickness directions of the electronic apparatus EA, is indicated by a third direction DR3. A front surface (or a top surface) and a rear surface (or a bottom surface) of each member may be separated by the third direction DR3.

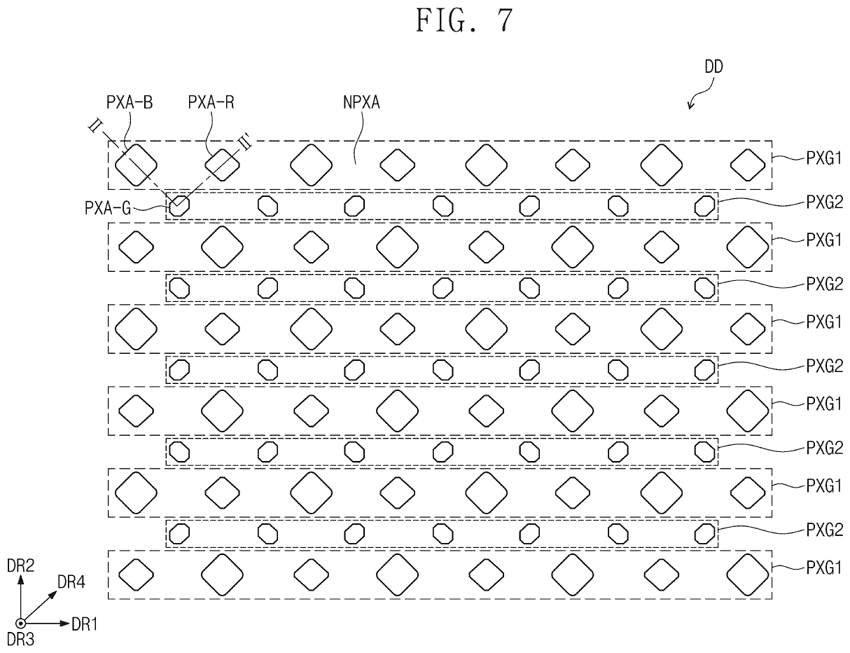

A fourth direction DR4 (see, e.g., FIG. 7) may be a direction between the first direction DR1 and the second direction DR2. The fourth direction DR4 may be positioned on a plane (e.g., in a plan view) parallel to the plane defined by the first direction DR1 and the second direction DR2. However, directions indicated by the first to fourth directions DR1, DR2, DR3, and DR4 are relative concepts, and may be changed to other directions.

In one or more embodiments, the electronic apparatus EA may include a foldable display device that includes a folding region and a non-folding region, or a bendable display device that includes at least one bending part.

The electronic apparatus EA may include a display device DD and a housing HAU. In the electronic apparatus EA, a front surface FS may correspond to a front surface of the display device DD, and correspond to a front surface of window WP. Therefore, the same reference numeral FS is used for the front surface of the electronic apparatus EA, the front surface of the display device DD, and the front surface of the window WP.

The housing HAU may receive a display device DD. The housing HAU may be arranged covering the display device DD such that a top surface, which is the display surface of the display device DD, is exposed. The housing HAU may cover a side surface and a bottom surface of the display device DD, and a whole top surface may be exposed. However, the present disclosure is not limited thereto, and the housing HAU may cover a portion of the top surface as well as the side and the bottom surface of the display device DD.

In the electronic apparatus EA according to one or more embodiments, the window WP may include an optically transparent insulating material. The window WP may include a transmission region TA and a bezel region BZA. The front surface FS of the window WP including the transmission region TA and the bezel region BZA corresponds to the front surface FS of the electronic apparatus EA.

In FIG. 1 and FIG. 2, the transmission region TA is illustrated as a rectangular shape having rounded corners. However, this is merely shown as an example, the transmission region TA may have one or more suitable shapes, and is not limited to any one embodiment.

The transmission region TA may be a region that is optically transparent. The bezel region BZA may have relatively lower light transmittance than the transmission region TA. The bezel region BZA may have a set or predetermined color. The bezel region BZA may be adjacent to the transmission region TA and be around (e.g., surround) the transmission region TA. The bezel region BZA may define a shape of the transmission region TA. However, the present disclosure is not limited thereto, and the bezel region BZA may be arranged adjacent to only one or more sides of the transmission region TA, and some portions may not be provided.

The display device DD may be arranged below the window WP. As used herein, the term “below” refers to a direction opposite to the direction in which the display device DD provides an image.

In one or more embodiments, the display device DD may be a structure that generates an image IM. The image IM generated from the display device DD is displayed on the display surface IS, and viewed to the user from the outside through the transmission region TA. The display device DD may include a display region DA and a non-display region NDA. The display region DA may be a region activated in response to an electrical signal. The non-display region NDA may be a region covered by the bezel region BZA. The non-display region NDA is adjacent to the display region DA. The non-display region NDA may be around (e.g., surround) the display region DA.

Referring to FIG. 3, the display device DD may include a display panel DP and a light control layer PP. The display panel DP may include a display element layer DP-EL. The display element layer DP-EL includes a light-emitting element ED (see, e.g., FIG. 4).

The light control layer PP may be arranged on the display panel DP to thereby control external light on the display panel DP by reflecting the external light, for example. The light control layer PP may include, for example, a polarizing layer or color filter layer.

In the display panel DD according to one or more embodiments, the display panel DP may be a luminous type or kind display panel. For example, the display panel DP may be a quantum dot emission display panel including a quantum dot light-emitting element. However, the present disclosure is not limited thereto.

The display panel DP may include a base substrate BS, a circuit layer DP-CL arranged on the base substrate BS, and a display element layer DP-EL arranged on the circuit layer DP-CL.

The base substrate BS may be a member providing a base surface on which the circuit layer DP-CL is arranged. The base substrate BS may be a glass substrate, a metal substrate, a plastic substrate, and/or the like. However, the present disclosure is not limited thereto, and the base substrate BS may be an inorganic layer, an organic layer, or a complex material layer. The base substrate BS may be a flexible substrate that may be easily bent or folded.

In one or more embodiments, the circuit layer DP-CL may be arranged on the base substrate BS, and the circuit layer DP-CL may include a plurality of transistors. The transistors may each include a control electrode, an input electrode, and an output electrode. For example, the circuit layer DP-CL may include a switching transistor and a driving transistor for driving a light-emitting element ED of the display element layer DP-EL.

FIG. 4 is a view illustrating the light-emitting element ED according to one or more embodiments of the present disclosure, and referring to FIG. 4, the light-emitting element ED according to one or more embodiments may include a first electrode EL1, a second electrode EL2 facing the first electrode EL1, and a plurality of functional layers arranged between the first electrode EL1 and the second electrode EL2, and including the emission layer EML.

The plurality of functional layers may include a hole transport region HTR arranged between the first electrode EL1 and the emission layer EML and an electron transport region ETR arranged between the emission layer EML and the second electrode EL2. In one or more embodiments, a capping layer may be further arranged on the second electrode EL2.

The hole transport region HTR and the electron transport region ETR may each include a plurality of functional sub-layers. For example, the hole transport region HTR may include a hole injection layer HIL and a hole transport layer HTL as functional sub-layers, and the electron transport region ETR may include an electron injection layer EIL and an electron transport layer ETL as functional sub-layers. However, the present disclosure is not limited thereto, the hole transport region HTR may further include an electron blocking layer, and/or the like as a functional sub-layer, and the electron transport region ETR may further include a hole blocking layer and/or the like as a functional sub-layer.

In the light-emitting element ED according to one or more embodiments, the first electrode EL1 has conductivity (e.g., is a conductor). The first electrode EL1 may be formed of a metal alloy, or a conductive compound. The first electrode EL1 may be an anode. The first electrode EL1 may be a pixel electrode.

In the light-emitting element ED according to one or more embodiments, the first electrode EL1 may be a reflective electrode. However, the present disclosure is not limited thereto. For example, the first electrode EL1 may be a transmissive electrode, a transflective electrode, and/or the like. When the first electrode EL1 is a transflective electrode or a reflective electrode, the first electrode EL1 may include Ag, Mg, Cu, Al, Pt, Pd, Au, Ni, Nd, Ir, Cr, Li, Ca, LiF/Ca, LiF/Al, Mo, Ti, a (e.g., any suitable) compound thereof and/or a (e.g., any suitable) mixture thereof (for example, a mixture of Ag and Mg). In one or more embodiments, the first electrode EL1 may have a multilayer structure including a reflective film or a transmissive film, each formed of materials previously described, and a transparent conductive film formed of indium tin oxide (ITO), indium zinc oxide (IZO), zinc oxide (ZnO), indium tin zinc oxide (ITZO), and/or the like. For example, the first electrode EL1 may be a multilayered metal film, and may be a structure of ITO/Ag/ITO in which the metal films are stacked.

The hole transport region HTR is provided on the first electrode EL1. The hole transport region HTR may include a hole injection layer HIL, a hole transport layer HTL, and/or the like. In one or more embodiments, the hole transport layer HTR may further include at least one selected from among a hole buffer layer and an electron blocking layer, in addition to the hole injection layer HIL and the hole transport layer HTL. The hole buffer layer compensates for a resonance distance depending on a wavelength of light emitted to thereby increase light emission efficiency. For materials included in the hole buffer layer, materials that may be included in the hole transport region HTR may be used. The electron blocking layer serves to prevent or substantially prevent electrons from being injected from the electron transport region ETR into the hole transport region HTR.

The hole transport region HTR may have a single layer formed of a single material, a single layer formed of a plurality of different materials, or a multi layered structure having a plurality of layers formed of different materials. For example, the hole transport region HTR may have a single-layered structure formed of different materials, or may have a structure such as hole injection layer (HIL)/hole transport layer HTL, hole injection layer HIL/hole transport layer HTL/hole buffer layer, hole injection layer HIL/hole buffer layer, hole transport layer HTL/hole buffer layer and/or hole injection layer HIL/hole transport layer HTL/electron blocking layer, in which layers are sequentially stacked from the first electrode EL1. However, the present disclosure is not limited thereto.

The hole transport region HTR may be formed using one or more suitable methods such as a vacuum deposition method, a spin coating method, a cast method, the Langmuir-Blodgett (LB) method, an ink jet printing method, a laser printing, and/or a laser induced thermal imaging (LITI) method.

The hole injection layer HIL may include, for example, a phthalocyanine compound such as copper phthalocyanine, N,N′-diphenyl-N, N′-bis-[4-(phenyl-m-tolyl-amino)-phenyl]-biphenyl-4,4′-diamine (DNTPD), 4,4′,4″-[tris(3-methylphenyl)phenylamino] triphenylamine (m-MTDATA), 4,4′4″-tris(N,N-diphenylamino)triphenylamine (TDATA), 4,4′,4″-tris {N,-(2-naphthyl)-N-phenylamino}-triphenylamine (2-TNATA), poly(3,4-ethylenedioxythiophene)/poly(4-styrenesulfonate) (PEDOT/PSS), polyaniline/dodecylbenzenesulfonic acid (PANI/DBSA), polyaniline/camphor sulfonic acid (PANI/CSA), polyaniline/poly(4-styrenesulfonate) (PANI/PSS), N,N′-di(naphthalene-I-yl)-N,N′-diphenyl-benzidine (NPD), polyether ketone containing triphenylamine (TPAPEK), 4-Isopropyl-4′-methyldiphenyliodonium[tetrakis(pentafluorophenyl) borate], dipyrazino[2,3-f: 2′,3′-h] quinoxaline-2,3,6,7,10,11-hexacarbonitrile (HAT-CN), and/or the like.

The hole transport layer HTL may include a general material suitable in the technical art. For example, hole transport layer HTL may further include a carbazole-based derivative such as N-phenyl carbazole, and polyvinyl carbazole, a fluorene-based derivative, a triphenylamine-based derivative such as N,N′-bis(3-methylphenyl)-N,N′-diphenyl-[1,1-biphenyl]-4,4′-diamine (TPD) and/or 4,4′,4″-tris(N-carbazolyl)triphenylamine (TCTA), N,N′-di(naphthalene-I-yl)-N,N′-diphenyl-benzidine (NPD), 4,4′-cyclohexylidene bis[N,N-bis(4-methylphenyl)benzenamine] (TAPC), 4,4′-bis[N,N′-(3-tolyl)amino]-3,3′-dimethylbiphenyl (HMTPD), 1,3-bis(N-carbazolyl)benzene (mCP), and/or the like.

The hole transport region HTR may have a thickness of about 5 nm to about 1500 nm, and for example, about 10 nm to about 500 nm. The hole injection layer HIL may have a thickness, for example, about 3 nm to about 100 nm, and the hole transport layer HTL may have a thickness of about 3 nm to about 100 nm. For example, the electron blocking layer may have a thickness of about 1 nm to about 100 nm. When the thicknesses of each of the hole transport region HTR, the hole injection layer HIL, the hole transport layer HTL, and the electron blocking layer fall within the above-mentioned ranges, satisfactory or suitable hole transport properties may be obtained without an increase in a driving voltage.

The emission layer EML may be provided on the hole transport region HTR. The emission layer EML may include a plurality of quantum dots QDs.

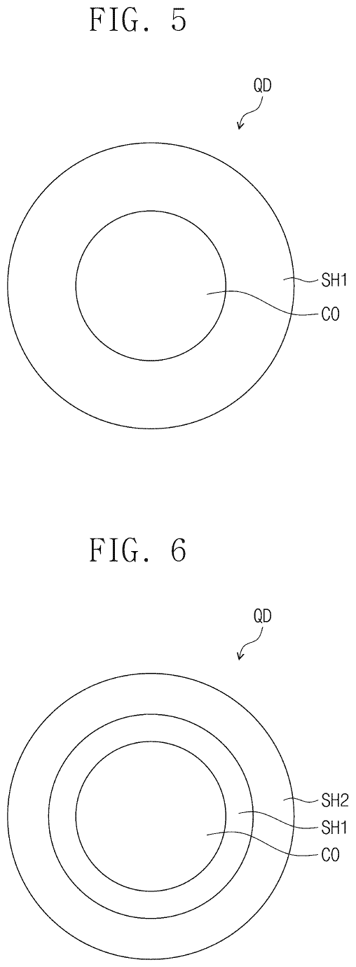

The quantum dots QDs included in the emission layer EML may be stacked to thereby form a layer. FIG. 4 illustrates, as an example, that the quantum dots QDs, of which each cross-section is (substantially) circular, are arranged to thereby form two layers, but the present disclosure is not limited thereto. For example, the arrangement of the quantum dots QDs may vary according to a thickness of the emission layer EML, a shape of the quantum dot QD included in the emission layer EML, an average diameter of the quantum dot QD, and/or the like. For example, in the emission layer EML, the quantum dots QDs may be arranged to be adjacent to each other, and thus may form one layer, or form a multilayered structure such as a two-layered or three-layered structure. The quantum dot QD according to one or more embodiments will be described in more detail with reference to FIG. 5 and FIG. 6.

In one or more embodiments, in the light-emitting element ED according to one or more embodiments, the emission layer EML may include a host and a dopant. In one or more embodiments, the emission layer EML may include the quantum dot QD as a dopant material. In one or more embodiments, the emission layer EML may further include a host material.

In the light-emitting element ED according to one or more embodiments, the emission layer EML may be to emit fluorescence. For example, the quantum dot QD may be used as a fluorescent dopant material.

In the light-emitting element ED according to one or more embodiments, the electron transport region ETR may be provided on the emission layer EML. The electron transport region ETR may include at least one selected from among a hole-blocking layer, an electron transport layer ETL, and an electron injection layer EIL, but the present disclosure is not limited thereto.

The electron transport region ETR may have a single layer formed of a single material, a single layer formed of a plurality of different materials, or a multilayer structure having a plurality of layers formed of a plurality of different materials.

For example, the electron transport region ETR may have a single-layered structure of the electron injection layer EIL or the electron transport layer ETL, or may have a single-layered structure formed of an electron injection material and an electron transport material. In one or more embodiments, the electron transport region ETR may have a single-layered structure formed of a plurality of different materials or may have a structure of electron transport layer ETL/electron injection layer EIL, or hole-blocking layer/electron transport layer ETL/electron injection layer EIL, in which each layer is sequentially stacked from the emission layer EML. However, the present disclosure is not limited thereto. The electron transport region ETR may have a thickness of, for example, about 20 nm to about 150 nm.

The electron transport region ETR may be formed using one or more suitable methods such as a vacuum deposition method, a spin-coating method, a cast method, the Langmuir-Blodgett method, an inkjet printing method, a laser printing method, and/or a laser induced thermal imaging (LITI) method.

When the electron transport region ETR includes the electron transport layer ETL, the electron transport region ETR may include an anthracene-based compound. However, the present disclosure is not limited thereto, and the electron transport region may include, for example, tris(8-hydroxyquinolinato)aluminum (Alq₃), 1,3,5-tri[(3-pyridyl)-phen-3-yl]benzene, 2,4,6-tris(3′-(pyridin-3-yl) biphenyl-3-yl)-1,3,5-triazine, bis[2-(diphenylphosphino)phenyl]ether oxide (DPEPO), 2-(4-(N-phenylbenzoimidazolyl-1-ylphenyl)-9,10-dinaphthylanthracene, 1,3,5-tri (1-phenyl-1H-benzo[d]imidazol-2-yl)phenyl (TPBi), 2,9-dimethyl-4,7-diphenyl-1,10-phenanthroline (BCP), 4,7-Diphenyl-1,10-phenanthroline (Bphen), 3-(4-biphenylyl)-4-phenyl-5-tert-butylphenyl-1,2,4-triazole (TAZ), 4-(Naphthalen-1-yl)-3,5-diphenyl-4H-1,2,4-triazole (NTAZ), 2-(4-biphenylyl)-5-(4-tert-butylphenyl)-1,3,4-oxadiazole (tBu-PBD), bis(2-methyl-8-quinolinolato-N1,O8)-(1,1′-biphenyl-4-olato)aluminum (BAlq), berylliumbis(benzoquinolin-10-olate (Bebq₂), 9,10-di(naphthalene-2-yl) anthracene (ADN), and/or a (e.g., any suitable) mixture thereof. The electron transport layers ETLs may have a thickness of about 10 nm to about 100 nm, and for example, about 15 nm to about 50 nm. When the thicknesses of the electron transport layers ETLs fall within the above-described ranges, satisfactory or suitable electron transport properties may be obtained without a substantial increase in driving voltage.

When the electron transport region ETR includes the electron injection layer EIL, halogenated metals such as LiF, NaCl, CsF, RbCl, and RbI, lanthanide metals such as Yb, metal oxides such as LiO, BaO, and/or LiQ (lithium quinolate) may be used in the electron transport region ETR, but the present disclosure is not limited thereto. The electron injection layer EIL may also be formed of a mixed material of the electron transport material and an organometal salt having conductivity (e.g., a conductor). For example, the organometal slat may include metal acetates, metal benzoates, metal acetoacetates, metal acetylacetonates, and/or metal stearates. The electron injection layers EILs may have a thickness of about 0.1 nm to about 10 nm, and about 0.3 nm to about 9 nm. When the thicknesses of the electron injection layers EILs fall within the above-described ranges, satisfactory or suitable electron injection properties may be obtained without a substantial increase in driving voltage.

The electron transport region ETR, as previously described, may include a hole-blocking layer. The hole-blocking layer may include, for example, at least one selected from among 2,9-dimethyl-4,7-diphenyl-1,10-phenanthroline (BCP) and 4,7-diphenyl-1,10-phenanthroline (Bphen), but the present disclosure is not limited thereto.

The second electrode EL2 may be provided on the electron transport region ETR. The second electrode EL2 may be a common electrode, or a negative electrode. The second electrode EL2 may be a transmissive electrode, a transflective electrode, or a reflective electrode. When the second electrode EL2 is a transmissive electrode, the second electrode EL2 may be formed of a transparent metal oxide, for example, indium tin oxide (ITO), indium zinc oxide (IZO), zinc oxide (ZnO), indium tin zinc oxide (ITZO), and/or the like.

When the second electrode EL2 is a transflective electrode or a reflective electrode, the second electrode EL2 may include Ag, Mg, Cu, Al, Pt, Pd, Au, Ni, Nd, Ir, Cr, Li, Ca, LiF/Ca, LiF/Al, Mo, Ti, Yb, or a (e.g., any suitable) compound containing the same (for example, AgYb, AgMg and MgAg compounds depending on contents), and/or a (e.g., any suitable) mixture thereof (for example, a mixture Ag and Mg). In one or more embodiments, the second electrode EL2 may have a multilayered structure including a reflective film or a transflective film, each formed of the material previously described, and a transparent conductive film formed of indium tin oxide (ITO), indium zinc oxide (IZO), zinc oxide (ZnO), indium tin zinc oxide (ITZO), and/or the like.

In one or more embodiments, the second electrode EL2 may be connected to an auxiliary electrode. When the second electrode EL2 is connected to the auxiliary electrode, a resistance of the second electrode EL2 may decrease.

FIG. 5 is a view schematically illustrating a structure of a quantum dot according to one or more embodiments of the present disclosure. FIG. 6 is a view schematically illustrating a structure of a quantum dot according to one or more embodiments of the present disclosure.

Referring to FIG. 5, the quantum dot QD may include a core CO, and a first shell SH1 covering (e.g., around or surrounding) the core CO. In FIG. 6, the quantum dot QD further includes a second shell SH2 covering (e.g., around or surrounding) the first shell SH1, which is a difference from the quantum dot QD in FIG. 5. The core CO may include a Group I-III-VI semiconductor compound. The core CO may be a quaternary CuInGaS compound in Group I-III-VI. The core CO may include copper (Cu), indium (In), gallium (Ga), and sulfur(S). The core CO may be formed of copper, indium, gallium, and sulfur. The quantum dot QD according to one or more embodiments includes the core CO containing the Group I-III-VI semiconductor compound, and thus may have a high blue light absorption rate. In one or more embodiments, the quantum dot QD may be a non-Cd-based quantum dot. For example, the core CO of the quantum dot QD may include no cadmium (Cd).

The quantum dot QD may include, with respect to the mass of the quantum dot QD of 100 wt %, about 5 wt % to about 20 wt % of copper, about 5 wt % to about 50 wt % of gallium, about 5 wt % to about 50 wt % of indium, and about 30 wt % to about 50 wt % of sulfur. In the core CO, the mass ratio of gallium may be greater than the mass ratio of indium. For example, in the quantum dot QD, about 6.2 wt % of copper, about 10.8 wt % of gallium, about 7.7 wt % of indium, and about 44.9 wt % of sulfur may be included. The content (e.g., amount) of each element (e.g., copper, indium, gallium, and sulfur) contained in the core CO is adjusted within the above-described ranges, and thus the quantum dot QD according to one or more embodiments may have improved color reproductivity and light absorption properties. The content (e.g., amount) of each element (e.g., copper, indium, gallium, and sulfur) contained in the core CO is varied within the above-described ranges, and thus the quantum dot QD according to one or more embodiments may be adjusted so as to emit light with a desired or suitable emission wavelength. For example, if (e.g., when) the content (e.g., amount) of each element contained in the core CO falls within the above-described ranges, the quantum dot QD may be to emit light with an emission wavelength of about 560 nm to about 600 nm. Accordingly, the quantum dot QD may be to emit green light having high color purity.

In one or more embodiments, the core CO may have a diameter of about 3 nm to about 6 nm. For example, the core CO may have a diameter of about 3.9 nm. If the core CO has a large diameter, light absorption properties may be excellent or suitable, contributing to high quantum efficiency. An average diameter of the core CO is variously chosen in the above-described ranges, and thus an emission wavelength of the quantum dot QD, semiconductor properties of the quantum dot, and/or the like may vary.

The core CO containing copper, indium, gallium, and sulfur may have an absorption wavelength of about 350 nm to about 530 nm. Therefore, the core CO may be to absorb blue light in the above-described wavelength range, and may be to emit green light or red light. The emission wavelength of light emitted from the quantum dot QD may be adjusted by adjusting the core CO size, the thickness of the first shell SH1, the thickness of the second shell SH2, and/or the like. The first shell SH1 and the second shell SH2 may each independently have a thickness of about 0.5 nm to about 3 nm. The thickness of the second shell SH2 may be greater than the thickness of the first shell SH1. The thickness of the second shell SH2 may be substantially the same as 2-fold the thickness of the first shell SH1. For example, the first shell SH1 may have the thickness of about 1 nm, and the second shell may have the thickness of about 2 nm.

The first shell SH1 may contain a Group II-VI semiconductor compound. The first shell SH1 may contain ZnS. The first shell SH1 may be formed of ZnS.

The second shell SH2 may completely cover (e.g., may be around or may surround) the first shell SH1. Therefore, a surface of the quantum dot QD may be defined by an outer surface of the second shell SH2. The first shell SH1 may not be exposed in the quantum dot QD by being covered by the second shell SH2. The second shell SH2 may contain at least one selected from among ZnSe, ZnS, ZnTe, ZnO, ZnMg, ZnMgSe, ZnMgS, ZnMgAl, GaSe, GaTe, GaP, GaAs, GaSb, InAs, InSb, AlP, AlAs, AlSb, MnS, MnSe, MgS, and MgSe. For example, the second shell SH2 may include ZnS. A concentration of ZnS contained in the first shell SH1 may be different from a concentration of ZnS contained in the second shell SH2. From a portion adjacent to the core CO of the first shell SH1 to a portion adjacent to the exterior of the second shell SH2, the concentration of ZnS may be gradually changed. For example, from a portion adjacent to the core CO of the first shell SH1 to a portion adjacent to the exterior of the second shell SH2, the ZnS concentration may gradually increase. A mass ratio of Zn contained in the quantum dot QD may be about 10 wt % to about 50 wt % with respect to the total mass (100 wt %) of the quantum dot QD. The quantum dot QD according to one or more embodiments may include the second shell SH2 covering the first shell SH1, and thus may exhibit high optical stability and chemical stability. The second shell SH2 may have a single-layered structure or a multilayered structure. For example, the second shell SH2 may have a single layer formed of a single material, a single layer formed of a plurality of different materials, or a multilayered structure having a plurality of layers formed of a plurality of materials. When the second shell SH2 has a multilayered structure, compositions of each layer may differ. In this case, the compositions of each layer may be discontinuously changed in the second shell SH2, or may be continuously changed (e.g., may include a gradient in composition) in the second shell SH2.

The quantum dot QD according to one or more embodiments includes the first shell SH1 and the second shell SH2, and thus may have excellent or suitable passivation effects at (for) the core CO. Therefore, the quantum dot QD according to one or more embodiments may exhibit high quantum yield properties.

A shape of the quantum dots QD is not particularly limited as long as it is a shape generally used in the art, but, in one or more embodiments, quantum dots in the shape of spherical, pyramidal, multi-arm, or cubic nanoparticles, nanotubes, nanowires, nanofibers, nanoplatelets, and/or the like may be used. In one or more embodiments, the quantum dots QD may be (e.g., may each be) substantially or generally spherical.

The quantum dots QD may be to emit green light. The quantum dot QD may have an emission center wavelength of about 560 nm to about 600 nm. For example, the quantum dots QD may be to emit light having a maximum emission wavelength of about 560 nm to about 600 nm. However, the present disclosure is not limited thereto, and the quantum dots QD may be to emit red light. For example, the quantum dots QD may be to emit light having an emission center wavelength of about 630 nm to about 680 nm.

In one or more embodiments, the core CO may have about 60 nm to about 65 nm of a full width half maximum (FWHM) of an emission wavelength spectrum. For example, the core CO may have about 64 nm of a FWHM of an emission wavelength spectrum. The quantum dot QD according to one or more embodiments may have about 65 nm to about 70 nm of a full width half maximum (FWHM) of an emission wavelength spectrum. For example, the quantum dot QD may have about 75 nm of a full width half maximum (FWHM) of an emission wavelength spectrum. The full width of half maximum (FWHM) of the core CO is smaller than the full width of half maximum (FWHM) of the quantum dot QD due to the fact that the first shell SH1 is around (e.g., surrounds) the core CO, and the second shell SH2 is around (e.g., surrounds) the first shell SH1. When the first shell SH1 is around (e.g., surrounds) the core CO, and the second shell SH2 is around (e.g., surrounds) the first shell SH1, the full width of half maximum (FWHM) may increase, but the optical stability and the chemical stability of the quantum dot QD may (significantly) increase. In one or more embodiments, light emitted through the quantum dot QD may be emitted in all directions, and thus an optical viewing angle may be improved.

In one or more embodiments, the quantum dot QD may further include a ligand chemically bonded to a surface thereof. The ligand is chemically bonded to the surface of the quantum dot QD to thereby passivate the quantum dot QD. For example, the quantum dot QD may further include the ligand chemically bonded to the second shell SH2. In one or more embodiments, the ligand may include an organic ligand or a halogenated metal.

In one or more embodiments, the quantum dot QD may have a quantum yield maintenance rate represented by Equation 1, of about 78%. Because the quantum yield maintenance rate of the quantum dot QD is about 78% or more, the quantum dot QD may exhibit excellent or suitable chemical stability, and thus alteration due to a purification process or an outer environment may be suppressed or reduced.

Quantum yield maintenance rate=X₁/X₀, Equation 1

In Equation 1 above, X₁ is the quantum yield of the quantum dot, as measured after performing the purification 2 times using ethanol, and X₀ is the quantum yield of the quantum dot, as measured before the purification.

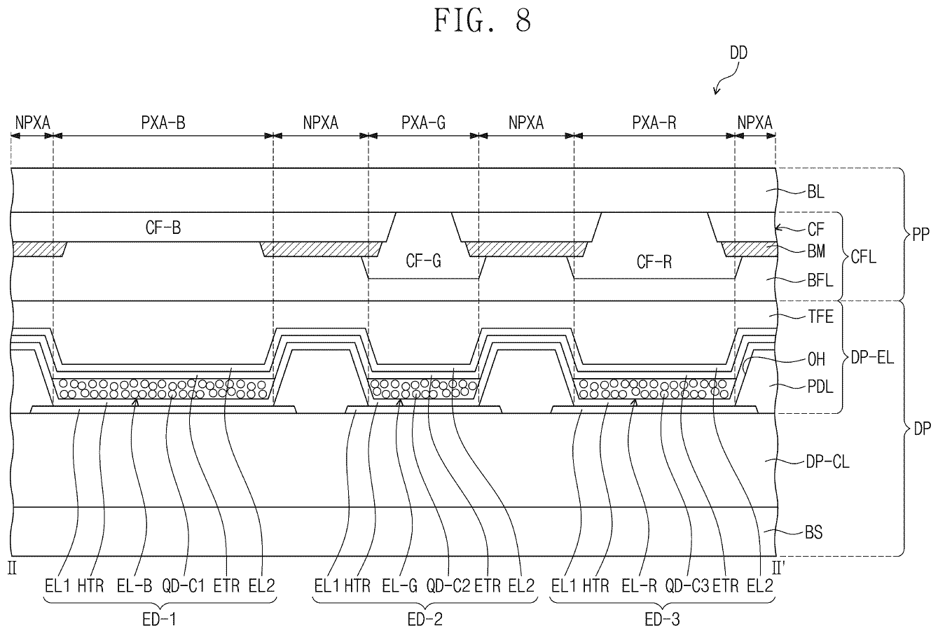

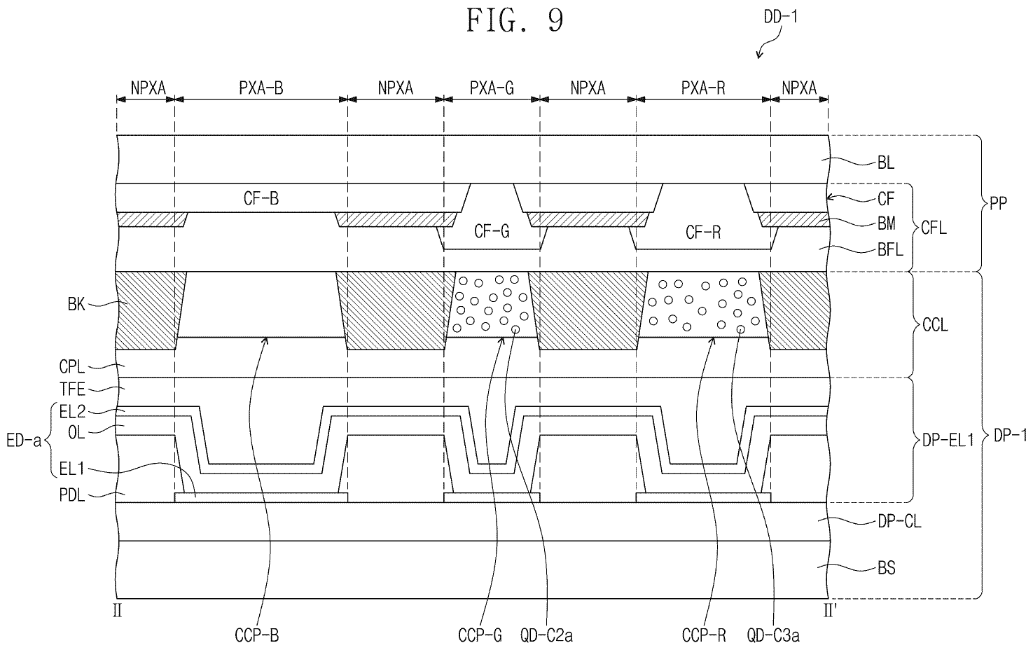

FIG. 7 is a plan view illustrating a portion of the display device DD that is enlarged, according to one or more embodiments of the present disclosure. FIG. 8 is a cross-sectional view the display device DD according to one or more embodiments of the present disclosure. FIG. 8 illustrates a portion taken along the line II-II′ in FIG. 7. FIG. 9 is a cross-sectional view of a display device DD-1 according to one or more embodiments of the present disclosure. FIG. 9 illustrates a portion of the display region DA of the display panel DP according to one or more embodiments of the present disclosure. FIG. 9 illustrates a portion taken along the line II-II′ in FIG. 7.

Referring to FIG. 7 to FIG. 9, the display device DD may include a non-emission region NPXA and an emission regions PXA-B, PXA-G, and PXA-R. Each of emission regions PXA-B, PXA-G, and PXA-R may be a region emitting light generated in the light-emitting elements ED-1, ED-2, and ED-3, respectively. The emission regions PXA-B, PXA-G, and PXA-R may be spaced and/or apart (e.g., spaced apart or separated) on the plane.

The emission regions PXA-B, PXA-G, and PXA-R may be divided into a plurality of groups depending on colors of light generated in the light-emitting elements ED-1, ED-2, and ED-3. In the display devices DD, and DD-1 according to one or more embodiments, illustrated in FIG. 7 to FIG. 9, the three emission regions PXA-B, PXA-G, and PXA-R, respectively emitting blue light, green light, and red light, are illustrated as an example. For example, the display devices DD and DD-1 according to one or more embodiments may include blue emission region PXA-B, green emission region PXA-G, and red emission region PXA-R, which are distinguished from each other.

Referring to FIG. 7, the blue emission regions PXA-Bs and the red emission regions PXA-Rs may be arranged by turns (e.g., alternated) along the first direction DR1 to form a first group PXG1. The green emission regions PXA-Gs may be arranged along the first direction DR1 to form a second group PXG2. The first group PXG1 may be arranged away from the second group PXG2 in the second direction DR2. The first group PXG1 and the second group PXG2 may each be provided in a plurality. The first groups PXG1s and the second groups PXG2s may be arranged by turns (e.g., alternated) along the second direction DR2. One green emission region PXA-G may be arranged away from one blue emission region PXA-B, or one red emission region PXA-R in a fourth direction DR4. The fourth direction DR4 may be a direction between the first direction DR1 and the second direction DR2. An arrangement structure of the emission regions PXA-B, PXA-G, and PXA-R, illustrated in FIG. 7, may be referred to as the Pentile® structure (Pentile® is a registered trademark of Samsung Display CO., Ltd., a Korean corporation).

However, the present disclosure is not limited thereto, and the emission regions PXA-B, PXA-G, and PXA-R may variously have a polygonal or circular shape, and the arrangement structure of the emission regions is also not limited. For example, the emission regions PXA-B, PXA-G, and PXA-R, along the first direction DR1, have a stripe structure, in which the blue emission region PXA-B, the green emission regions PXA-G, and the red emission region PXA-R are sequentially arranged by turns (e.g., alternated), or may have a diamond pixel arrangement.

Referring to FIG. 8, a plurality of light-emitting elements ED-1, ED-2, and ED-3 may be to emit light in different wavelength ranges. For example, in one or more embodiments, the display device DD may include a first light-emitting element ED-1 to emit blue light, a second light-emitting element ED-2 to emit green light, and a third light-emitting element ED-3 to emit red light. However, the present disclosure is not limited thereto, and the first to third light-emitting elements ED-1, ED-2, and ED-3 may be to emit light in substantially the same wavelength region, or at least one may be to emit light in a different wavelength region than the embodiment described above.

For example, the blue emission region PXA-B, the green emission region PXA-G, and the red emission region PXA-R of the display device DD may correspond to the first light-emitting element ED-1, the second light-emitting element ED-2, and the third light-emitting element ED-3, respectively.

The display device DD according to one or more embodiments includes a plurality of light-emitting elements ED-1, ED-2, and ED-3, and at least one selected from among the light-emitting elements ED-1, ED-2, and ED-3 may include emission layers EL-B, EL-G, and EL-R containing quantum dots QD-C1, QD-C2, and QD-C3 according to one or more embodiments.

In one or more embodiments, the display device DD may include a display panel DP including a plurality of light-emitting elements ED-1, ED-2, and ED-3, and a light control layer PP arranged on the display panel DP. In one or more embodiments, in the display device DD according to one or more embodiments, the light control layer PP may not be provided.

The display panel DP may include a base substrate BS, a circuit layer DP-CL provided on the base substrate BS, and a display element layer DP-EL, and the display element layer DP-EL may include a pixel definition film PDL, light-emitting elements ED-1, ED-2, and ED-3 arranged between portions of the pixel definition film PDL, and an encapsulation layer TFE arranged on the light-emitting elements ED-1, ED-2, and ED-3.

The first emission layer EL-B of the first light-emitting element ED-1 may include a first quantum dot QD-C1. The first quantum dot QD-C1 may be to emit blue light, which is first light.

The second emission layer EL-G of the second light-emitting element ED-2 and the third emission layer EL-R of the third light-emitting element ED-3 may include a second quantum dot QD-C2 and a third quantum dot QD-C3, respectively. The second quantum dot QD-C2 and the third quantum dot QD-C3 may be to emit green light that is second light and red light that is third light, respectively.

At least one selected from among the first to third quantum dots QD-C1, QD-C2, and QD-C3 may be a quantum dot according to one or more of the above-described embodiments. In one or more embodiments, the second quantum dot QD-C2 may be the quantum dot according to one or more of the above-described embodiments. However, the present disclosure is not limited thereto, and each of the first to third quantum dots QD-C1, QD-C2, and QD-C3 may be the quantum dot according to one or more of the above-described embodiments.

In one or more embodiments, the first to third quantum dots QD-C1, QD-C2, and QD-C3 included in the light-emitting elements ED-1, ED-2, and ED-3 may be formed of different core materials. In one or more embodiments, the first to third quantum dots QD-C1, QD-C2, and QD-C3 may be formed of the same core material, or two quantum dots selected from among the first to third quantum dots QD-C1, QD-C2, and QD-C3 may be formed of the same core materials, and the rest may be formed of a different core material.

In one or more embodiments, the first to third quantum dots QD-C1, QD-C2, and QD-C3 may have different diameters. For example, the first quantum dot QD-C1 used in the first light-emitting element ED-1 that emits light in a relatively short wavelength region may have a relatively smaller average diameter than the second quantum dot QD-C2 used in the second light-emitting element ED-2 and the third quantum dot QD-C3 used in the third light-emitting element ED-3 that emit light in a relatively long wavelength region.

In one or more embodiments, as used herein, the average diameter corresponds to an arithmetic mean value of the diameters of a plurality of quantum dot particles. In one or more embodiments, the diameter of the quantum particle may be an average value of widths (e.g., diameters or major axes) of the quantum dot particles on the cross-section.

A relationship between the first to third quantum dots QD-C1, QD-C2, and QD-C3 and the average diameter is not limited to the description above. For example, FIG. 8 illustrates that the first to third quantum dots QD-C1, QD-C2, and QD-C3 included in the light-emitting elements ED-1, ED-2, and ED-3, have a similar size to each other, but the first to third quantum dots QD-C1, QD-C2, and QD-C3 may have different size. In one or more embodiments, two quantum dots selected from among the first to third quantum dots QD-C1, QD-C2, and QD-C3 may have the same diameter, and the rest may have a different size (e.g., different diameter).

In the display device DD according to one or more embodiments, as illustrated in FIG. 7 and FIG. 8, the area of each of the emission regions PXA-B, PXA-G, and PXA-R may be different. In this case, the area may refer to an area when viewed on the plane (e.g., in a plan view) defined by the first direction DR1, and the second direction DR2.

The emission regions PXA-B, PXA-G, and PXA-R may have different areas depending on the colors of light emitted in the emission layers EL-B, EL-G, and EL-R of the light-emitting elements ED-1, ED-2, and ED-3, respectively. For example, referring to FIG. 7 and FIG. 8, in the display device DD according to one or more embodiments, the blue emission region PXA-B corresponding to the first light-emitting element ED-1, which emits blue light, may have a greatest area, and the green emission region PXA-G corresponding to the second light-emitting element ED-2, which emits green light, may have a smallest area. However, the present disclosure is not limited thereto, the emission regions PXA-B, PXA-G, and PXA-R may be to emit light with other colors than blue light, green light, and red light, the emission regions PXA-B, PXA-G, and PXA-R may have the same area, or the emission regions PXA-B, PXA-G, and PXA-R may be provided at a different area ratio as illustrated in FIG. 7.

Each of the emission regions PXA-B, PXA-G, and PXA-R may be a region separated by the pixel definition film PDL. The non-emission region NPXA may include regions between neighboring emission regions PXA-B, PXA-G, and PXA-R and may include (have) regions corresponding to regions of the pixel definition film PDL. In one or more embodiments, as used herein, each of the emission regions PXA-B, PXA-G, and PXA-R may correspond to a pixel. The pixel definition film PDL may separate the light-emitting elements ED-1, ED-2, and ED-3. The emission layers EL-B, EL-G, and EL-R of the light-emitting elements ED-1, ED-2 and ED-3 may be arranged in an opening part OH defined by the pixel definition film PDL to thereby be separated.

The pixel definition film PDL may be formed of a polymer resin. For example, the pixel definition film PDL may be formed including a polyacrylate-based resin, and/or a polyimide-based resin. In one or more embodiments, the pixel definition film PDL may be formed further including an inorganic material in addition to the polymer resin. Meanwhile the pixel definition film PDL may be formed including a light absorption material, or may be formed including a black pigment and/or a black dye. The pixel definition film PDL formed including a black pigment and/or a black dye may implement a black pixel definition film. During the forming of the pixel definition film PDL, carbon black and/or the like may be used as the black pigment and/or the black dye, but the present disclosure is not limited thereto.

In one or more embodiments, the pixel definition film PDL may be formed of an inorganic material. For example, the pixel definition film PDL may be formed including silicon nitride (SiNₓ), silicon oxide SiOₓ, silicon oxynitride (SiOₓN_{y}), and/or the like. The pixel definition film PDL may define the emission regions PXA-B, PXA-G, and PXA-R. The emission regions PXA-B, PXA-G, and PXA-R and the non-emission region NPXA may be defined by the pixel definition film PDL.

Each of the light-emitting elements ED-1, ED-2, and ED-3 may include a first electrode EL1, a hole transport region HTR, one of the emission layers EL-B, EL-G, an EML-R, respectively, an electron transport region ETR, and a second electrode EL2. In the light-emitting elements ED-1, ED-2, and ED-3 included in the display device DD, according to one or more embodiments, except that the quantum dots QD-C1, QD-C2, and QD-C3 included in the emission layers EL-B, EL-G, and EL-R are different from each other, the same descriptions as in FIG. 4, previously described, may be applied to the first electrode EL1, the hole transport region HTR, the electron transport region ETR, and the second electrode EL2. In one or more embodiments, each of the light-emitting elements ED-1, ED-2, and ED-3 may further include a capping layer between the second electrode EL2 and the encapsulation layer TFE.

The encapsulation layer TFE may cover the light-emitting elements ED-1, ED-2, and ED-3. One layer, or a plurality of layers may be stacked in the encapsulation layer TFE. The encapsulation layer TFE may be a thin encapsulation layer. The encapsulation layer TFE protects the light-emitting elements ED-1, ED-2, and ED-3. The encapsulation layer TFE may cover a top surface of the second electrode EL2 arranged in the opening part OH, and fill the opening part OH.

In one or more embodiments, in FIG. 8 and/or the like, the hole transport region HTR and the electron transport region ETR are illustrated to cover the pixel definition film PDL and to be provided as a common layer, but the present disclosure is not limited thereto. In one or more embodiments, the hole transport region HTR and the electron transport region ETR may be arranged in the opening part OH defined in the pixel definition film PDL.

For example, if (e.g., when) the hole transport region HTR, the electron transport region ETR, and/or the like are provided using an ink jet printing method in addition to the emission layers EL-B, EL-G, and EL-R, the hole transport region HTR, the emission layers EL-B, EL-G, and EL-R, the electron transport region ETR, and/or the like may be provided, corresponding to the opening part OH defined between the pixel definition film PDL. However, the present disclosure is not limited thereto, and, regardless of the method for providing each functional layer, as illustrated in FIG. 8 and/or the like, the hole transport region HTR and the electron transport region ETR may be provided as one common layer, while covering the pixel definition film PDL without being patterned.

In one or more embodiments, in the display device DD, as, for example, illustrated in FIG. 8, all the emission layers EL-B, EL-G, and EL-R of the first to third light-emitting elements ED-1, ED-2, and ED-3 are illustrated as having a similar thickness, but the present disclosure is not limited thereto. For example, in one or more embodiments, the emission layers EL-B, EL-G, and EL-R of the first to third light-emitting elements ED-1, ED-2, and ED-3 may have different thicknesses.

Referring to FIG. 8, the display device DD according to one or more embodiments may further include a light control layer PP. The light control layer PP may block or reduce external light that is provided to the display panel DP from the outside of the display device DD. The light control layer PP may block or reduce some of the external light. The light control layer PP may have anti-reflection function to minimize or reduce reflection due to the external light.

In one or more embodiments as illustrated in FIG. 8, the light control layer PP may include a color filter layer CFL. For example, the display device DD according to one or more embodiments may further include the color filter layer CFL arranged on the light-emitting elements ED-1, ED-2, and ED-3 of the display panel DP.

In the display device DD according to one or more embodiments, the light control layer PP may include a base layer BL, and a color filter layer CFL.

The base layer BL may be a member providing a base surface on which the color filter layer CFL and/or the like are arranged. The base layer BL may be a glass substrate, a metal substrate, a plastic substrate, and/or the like. However, the present disclosure is not limited thereto, and the base layer BL may be an inorganic layer, an organic layer, or a complex material layer.

The color filter layer CFL may include a blocking member BM and a color filter part CF. The color filter part CF may include a plurality of filters CF-B, CF-G, and CF-R. For example, the color filter layer CFL may include a first filter CF-B transmitting the first light, a second filter CF-G transmitting the second light, and a third filter CF-R transmitting the third light. For example, the first filter CF-B may be a blue filter, a second filter CF-G may be a green filter, and a third filter CF-R may be a red filter.

Each of the filters CF-B, CF-G, and CF-R may include a polymer photosensitive resin, a pigment and/or a dye. The first filter CF-B may include a blue pigment and/or dye, the second filter CF-G may include a green pigment and/or dye, and the third filter CF-R may include a red pigment and/or dye.

However, the present disclosure is not limited thereto, and the first filter CF-B may include no pigment or no dye. The first filter CF-B may include a polymer photosensitive resin, and may not include a pigment or a dye. The first filter CF-B may be transparent. The first filter CF-B may be formed of a transparent photosensitive resin.

The blocking member BM may be a black matrix. The blocking member BM may be formed including an organic blocking material or an inorganic blocking material, containing a black pigment and/or a black dye. The blocking member BM may prevent or reduce a light leakage phenomenon, and separate (define) a boundary between adjacent filters CF-B, CF-G, and CF-R. In one or more embodiments, the blocking member BM may be formed of a blue filter.

Each of the first to third filters CF-B, CF-G, and CF-R may be arranged corresponding to the red emission region PXA-R, the green emission region PXA-G, and the blue emission region PXA-B, respectively.

The color filter layer CFL may further include a buffer layer BFL. For example, the buffer layer BFL may be a protective layer protecting the filters CF-B, CF-G, and CF-R. The buffer layer BFL may be an inorganic layer containing at least one inorganic material among silicon nitride, silicon oxide, and silicon oxynitride. The buffer layer BFL may be formed of a single layer, or a plurality of layers.

In the color filter layer CFL according to one or more embodiments, the blocking member BM may not be provided, and each of the first to third filters CF-B, CF-G, and CF-R may be arranged so as to overlap each other in the non-emission region NPXA. The first to third filters CF-B, CF-G, and CF-R arranged so as to overlap each other in the non-emission region NPXA may perform a function of the omitted blocking member.

In one or more embodiments, the display device DD may include a polarizing layer in place of the color filter layer CFL, as a light control layer PP. The polarizing layer may block or reduce external light provided on the display panel DP from the outside. The polarizing layer may block or reduce some of the external light.

In one or more embodiments, the polarizing layer may reduce reflected light reflected on the display panel DP due to the external light. For example, the polarizing layer may function to block or reduce the reflected light in a case where light provided from the outside of the display device DD is incident on the display panel DP and emitted again (e.g., reflected). The polarizing layer may be a circular polarizer having an anti-reflection function or the polarizing layer may include a linear polarizer and a λ/4 phase retarder. In one or more embodiments, the polarizing layer may be arranged on the base layer BL to thereby be exposed, or the polarizing layer may be arranged below the base layer BL.

Referring to FIG. 9, a display device DD-1 according to one or more embodiments may include a light conversion layer CCL arranged on a display panel DP-1. In one or more embodiments, the display device DD-1 may further include a color filter layer CFL. In one or more embodiments, the display device DD-1 may further include a color filter layer CFL. The color filter layer CFL may be arranged between the base layer BL and the light conversion layer CCL.

The display panel DP-1 may be a luminous type or kind display panel. For example, the display panel DP-1 may be an organic electroluminescence display panel, or a quantum dot emission display panel.

The display panel DP-1 may include a base substrate BS, a circuit layer DP-CL provided on the base substrate BS and a display element layer DP-EL1.

The display element layer DP-EL1 may include a light-emitting element ED-a, and the light-emitting element ED-a may include a first electrode EL1 and a second electrode EL2, facing (e.g., opposite) each other, and a plurality of layers OLs arranged between the first electrode EL1 and the second electrode EL2. The plurality of layers OLs may include a hole transport region HTR (see, e.g., FIG. 4), an emission layer EML (see, e.g., FIG. 4), and an electron transport region ETR (see FIG. 4). An encapsulation layer TFE may be arranged on the light-emitting element ED-a.

In the light-emitting element ED-a, the same descriptions as in FIG. 4 and FIG. 8 previously described, may be applied to the first electrode EL1, the hole transport region HTR, the electron transport region ETR, and the second electrode EL2. However, in the light-emitting element ED-a included in the display panel DP-1 according to one or more embodiments, the emission layer may include a host and a dopant, which are organic electroluminescence materials, or may include the quantum dot according to one or more of the above-described embodiment. In the display panel DP-1 according to one or more embodiments, the light-emitting element ED-a may be to emit blue light.

The light control layer CCL may include a plurality of partition walls BKs arranged away each other and the light control parts CCP-B, CCP-G, and CCP-R between the partition walls BK. The partition walls BK may be formed by including a polymer resin and a liquid repellent additive. The partition walls BK may be formed by including a light absorbing material, or may be formed by including a pigment and/or dye. For example, the partition walls BK may include a black pigment and/or black dye to implement a black partition wall. When forming the black partition wall, carbon black and/or the like may be used as the black pigment, but the present disclosure is not limited thereto.

The light conversion layer CCL may include a first light control part CCP-B that transmits the first light, a second light control part CCP-G including a fourth quantum dot QD-C2a converting the first light to the second light, and a third light control part CCP-R including a fifth quantum dot QD-C3a converting the first light to the third color light. The second light may be light in a longer wavelength region than the first light, and the third light may be light in a longer wavelength region than the first light and the second light. For example, the first light may be blue light, the second light may be green light, and the third light may be red light. The same descriptions as the quantum dots according to one or more of the above-described embodiments may be applied to at least one selected from among the quantum dots QD-C2a and QD-C3a included in the light control parts CCP-B, CCP-G and CCP-R. For example, the same descriptions of the quantum dot according to one or more of the above-described embodiments may be applied to the fourth quantum dot QD-C2a converting the first light to second light.

The light conversion layer CCL may further include a capping layer CPL. The capping layer CPL may be arranged on the light control parts CCP-B, CCP-G and CCP-R, and the partition wall BK. The capping layer CPL may serve to prevent or reduce moisture and/or oxygen from penetrating into the display device DD-1. The capping layer CPL may be arranged on the light control parts CCP-B, CCP-G and CCP-R and may block or substantially block the light control parts CCP-B, CCP-G and CCP-R from being exposed to moisture and/or oxygen. The capping layer CPL may include at least one inorganic layer.

The display device DD-1 according to one or more embodiments may include a color filter layer CFL arranged on the light conversion layer CCL, and the same descriptions as in FIG. 8 may be applied to the color filter layer CFL and the base layer BL.

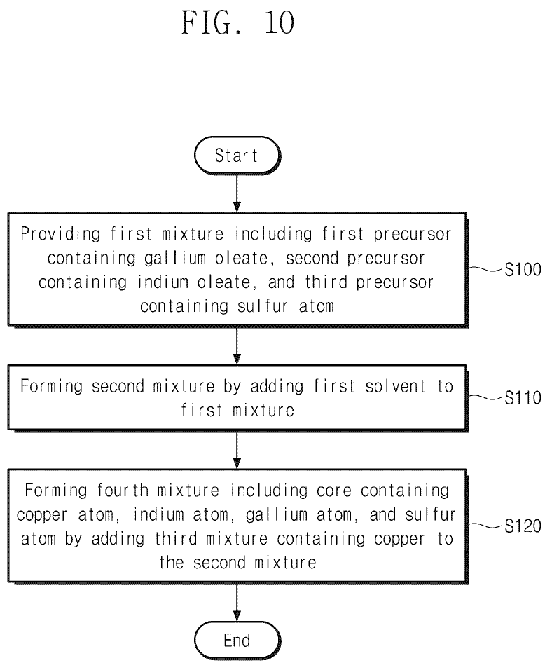

FIG. 10 is a flowchart showing a method for preparing the quantum dot according to one or more embodiments of the present disclosure. The overlapping parts with the above-described explanation of the quantum dot QD may not be provided.

Referring to FIG. 10, the method for preparing the quantum dots according to one or more embodiments include: providing a first mixture (S100) that contains a first precursor containing gallium oleate, a second precursor containing indium oleate, and a third precursor containing a sulfur atom; forming a second mixture (S120) by adding a first solvent to the first mixture; and forming a fourth mixture (S130) that contains a copper atom, an indium atom, a gallium atom, and a sulfur atom, by adding a third mixture containing copper to the second mixture.

In the providing of the first mixture (S100), gallium oleate contained in the first precursor may be synthesized by Reaction Scheme 1, and indium oleate contained in the second precursor may be synthesized by Reaction Scheme 2.

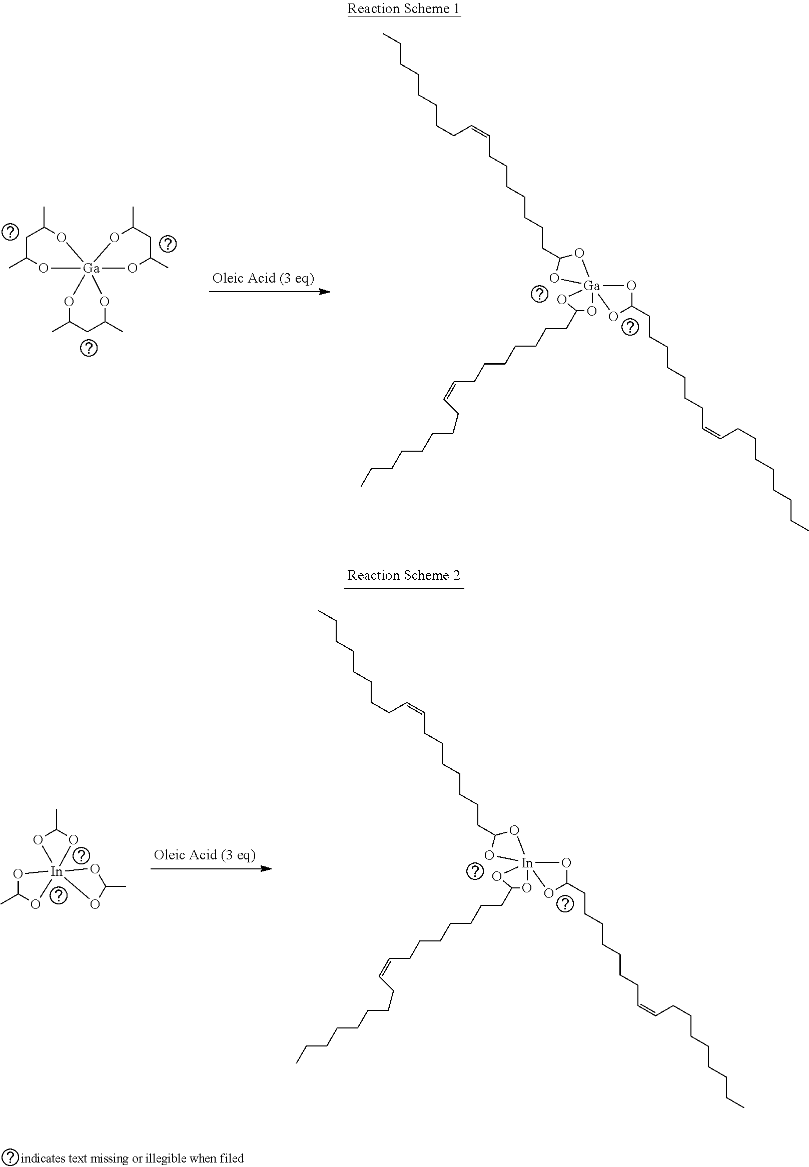

Gallium oleate and indium oleate adjust a chemical reaction rate during a core synthesizing process to thereby increase a diameter of the core, and to thereby make the core size relatively or substantially uniform, compared to the core prepared using a precursor containing gallium or indium, each unsubstituted with oleate. When the core has a large size, the light absorption properties may be improved, and if (e.g., when) the core size is substantially uniform, a full width at half maximum is improved, and thus color reproductivity may be excellent or suitable. Molarity of gallium oleate and indium oleate may each be about 0.5 M.

The third precursor containing a sulfur atom may be synthesized by Reaction Scheme 3.

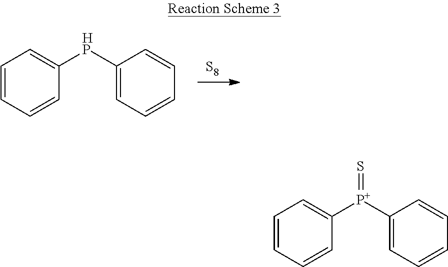

Molarity of the third precursor containing a sulfur atom may be about 1 M.

The first mixture may include, within certain amount ranges, the first precursor containing gallium oleate, the second precursor containing indium oleate, and the third precursor containing a sulfur atom. In the first mixture, a ratio of mol of gallium, indium, and a sulfur atom may be about 1:1:2. For example, in the first mixture, the molarity of the gallium atom may be about 0.5 M, the molarity of the indium atom may be about 0.5 M, and the molarity of the sulfur atom may be about 1 M.

In the forming of the second mixture (S120), the first solvent may include at least one selected from among 1-octadecene and trioctylamine. The first solvent may function to dissolve the first precursor, the second precursor, and the third precursor. 1-octadecene may not directly participate in a chemical reaction, and may contribute to concentration adjustment of the materials in the second mixture and viscosity of the second mixture. Trioctylamine may contribute to concentration adjustment of the materials in the second mixture and to a reaction rate adjustment.

The second mixture may include the first precursor containing gallium oleate, the second precursor containing indium oleate, and the third precursor containing a sulfur atom in a certain ratio. In the second mixture, the number of moles of the first precursor may be greater than the number of moles of the second precursor. For example, the number of moles of gallium atoms may be greater than the number of indium atoms. The second mixture may include the first precursor in an amount of about 0.5 mmol to about 0.7 mmol, the second precursor in an amount of about 0.3 mmol to about 0.5 mmol, and the third precursor in an amount of about 1.2 mmol to about 2.0 mmol. For example, the second mixture may include the first precursor, the second precursor, and the third precursor at a ratio of mol about 6:4:16.

The forming of the fourth mixture (S130) may include forming a core. The forming of the core may include, in a nitrogen atmosphere, forming the fourth mixture by adding a third mixture containing copper to the second mixture; and reacting the fourth mixture at a first temperature for about 5 minutes to about 15 minutes. In the forming of the fourth mixture, the third mixture containing copper may include copper acetate (Copper (I) acetate). In the reacting of the fourth mixture at the first temperature for about 5 minutes to about 15 minutes, the first temperature may be about 250° C. to about 350° C. For example, the fourth mixture may be reacted at about 250° C. for about 10 minutes. When the fourth mixture undergoes the reaction at the first temperature for about 5 minutes to about 15 minutes, the first precursor, the second precursor, and the third precursor, each contained in the second mixture, and copper contained in the third mixture may react to form a core. If the fourth mixture reacts at the first temperature, the formed plurality of cores have a substantially uniform size, and thus color reproductivity may be improved. The formed cores after the reaction may have a diameter (e.g., average diameter) of about 3 nm to about 6 nm. For example, the cores may have the diameter of about 3.9 nm. When the core has the large diameter, light absorption properties may be excellent or suitable, and the cores may contribute to a high quantum efficiency. The emission wavelength of the quantum dots QD (see, e.g., FIG. 4) and/or the semiconductor properties of the quantum dots may be variously changed by choosing a different average diameter of the core in the above-described range.

The method for preparing the quantum dot according to one or more embodiments may further include forming a first shell covering (e.g., around) the core by reacting the core, a fourth precursor containing zinc oleate and a fifth precursor containing a sulfur atom.

In the forming of the first shell, the fifth precursor may contain trioctylphosphine-sulfide. The fourth precursor and the fifth precursor may each independently have the number of moles of about 0.4 mmol to about 1.6 mmol. When the fourth precursor and the fifth precursor each independently have the number of moles of about 0.4 mmol to about 1.6 mmol, light absorption properties of the quantum dot and quantum efficiency may be improved. The molar ratio of the fourth precursor to the fifth precursor may be about 1:1. The number of moles of zinc oleate contained the fourth precursor and the number of moles of trioctylphosphine-sulfide contained in the fifth precursor may each be about 0.8 mmol. In the quantum dot, a mass of gallium atoms may be about 5 wt % (e.g., weight % or mass %) to about 50 wt % with respect to the total mass of 100 wt % the quantum dot. A mass ratio of gallium atoms to the quantum dot may be greater than a mass ratio of indium atoms to the quantum dot. With respect to the mass of the quantum dot, the mass of indium atoms may be about 5 wt % to about 50 wt %, the mass of copper may be about 5 wt % to about 20 wt %, the mass of sulfur atoms may be about 30 wt % to about 50 wt %, and the mass of zinc atoms may be about 10 wt % to about 50 wt %. For example, the quantum dot (e.g., each quantum dot or an average among the quantum dots) may include about 6.2 wt % of copper, about 10.8 wt % of gallium, about 7.7 wt % of indium, about 44.9 wt % of sulfur, and about 30.4 wt % of zinc.

The forming of the first shell may be performed at a second temperature for about 15 minutes to about 25 minutes. The second temperature may be about 280° C. to about 350° C. For example, the forming of the first shell may be performed at about 280° C. for about 20 minutes.

In the method for preparing the quantum dot according to one or more embodiments, the first solvent may include 1-octadecene and trioctylamine, and before the forming of the first shell, the method for preparing the quantum dot according to one or more embodiments may further include degassing trioctylamine at about 120° C. After the degassing of trioctylamine at about 120° C., the first solvent may include 1-octadecene and may include no trioctylamine. Trioctylamine has a function to slow down a chemical reaction, and thus, during the formation of the core, may contribute to substantial uniformity of the core diameter. However, during the forming process of the first shell, it is important to improve optical stability and chemical stability by rapidly forming the first shell. Therefore, if (e.g., when) trioctylamine is degassed, the first shell may be rapidly formed, thereby improving optical stability and chemical stability of the core. The first shell may have a thickness of about 0.5 nm to about 3 nm. For example, the first shell may have a thickness of about 1 nm. The thickness of the first shell is adjusted in a certain range, and thus decreases in the light absorption and emission properties may be minimized or reduced while the optical stability and the chemical stability of the core may be improved.

The method for preparing the quantum dot according to one or more embodiments, after the forming of the first shell, may further include forming a second shell covering (e.g., around) the first shell by adding a first element precursor, and a second element precursor to a first particle containing the core and the first shell.

In the forming of the second shell, the first element precursor may include at least one selected from among a zinc atom, a gallium atom, an indium atom, an aluminum atom, a manganese atom, and a magnesium atom. The second element precursor may include at least one selected from among a selenium atom, a sulfur atom, a tellurium atom, an oxygen atom, a phosphorus atom, an arsenic atom, and an antimony atom. For example, the first element precursor may include a zinc atom, and the second element precursor may include a sulfur atom. The first element precursor may be the same as the fourth precursor. The second element precursor may be the same as the fifth precursor.

Hereinafter, the quantum dot according to one or more embodiments of the present disclosure will be further explained while referring to an example and a comparative example. In addition, the example shown below is for illustration to assist in understanding the present disclosure, and the scope of the present disclosure is not limited thereto.

### EXAMPLE

### Synthesis of Quantum Dots According to Example 1

### Step 1: Synthesize of CuInGaS Core

0.3 mmol to 1 mmol of gallium oleate, 0.1 mmol to 0.5 mmol of indium oleate, and 0.1 mmol to 2 mmol of Cu(I) acetate were put into a flask with 10 mmol to 50 mmol of oleyamine, 1 mmol to 20 mmol of 1-octadecene, and 1 mmol to 20 mmol of trioctylamine and mixed, and then the mixture was degassed and stirred at about 120° C. for about 30 minutes to form a reaction solution. Then, 1 mmol to 2 mmol of diphenyl phosphine-sulfide was injected in the reaction solution, and in a state of being heated to about 250° C., the resultant was reacted for about 10 minutes to thereby synthesize CuInGaS cores.

### Step 2: Synthesize of CuInGaS/ZnS

The solution containing the synthesized CuInGaS cores was heated to about 120° C., and 20 mmol to 50 mmol of trioctylamine was degassed. Then, the atmosphere is substituted with nitrogen, the CuInGaS cores were diluted in toluene, and were precipitated with ethanol to be purified. 0.4 mmol to 1.6 mmol of zinc oleate and 0.4 mmol to 1.6 mmol of trioctylphosphine-sulfide were injected to the toluene solution containing 1 mmol to 2 mmol of the purified CuInGaS cores, and were reacted at about 280° C. for about 20 minutes to thereby form ZnS shells.

### Comparative Example

### Synthesis of Quantum Dot According to Comparative Example 1

### Step 1: Synthesis of CuInGaS Core

0.2 mmol of CuI, 0.5 mmol of Gal₃, and 0.4 mmol of InI₃ were put into a flask with 0.85 mmol of trioctylphosphine oxide (TOPO), 10 mmol to 50 mmol of oleyamine, and 1 mmol to 20 mmol of trioctylamine, and mixed. Then, the mixture was degassed and stirred at about 120° C. for about 30 minutes to form a reaction solution. Thereafter, in a nitrogen atmosphere, 0.4 mmol to 1.6 mmol of diphenyl phosphine-sulfide was injected into the reaction solution, and in a state of being heated to about 220° C., the resultant solution was reacted to thereby synthesize a CuInGaS core.

### Step 2: Synthesis of CuInGaS/ZnS

CuInGaS/ZnS was prepared in substantially the same manner as in synthesis step 2 of Example 1.

### Synthesis of Quantum Dot According to Comparative Example 2

### Step 1: Synthesis of InP Core

10 mmol of indium acetate, 10 mmol of zinc acetate, and 70 mmol of palmitic acid were mixed in a solvent of 50 mL of 1-octadecene with, as an additive, 4.5 mmol of oleyamine and 0.5 mmol of sodium oleate to prepare a cation precursor.

Tris(trimethylsilyl)phosphine and trioctylphosphine were mixed to prepare an anion precursor.

The manufactured two-type or kind precursors were mixed, and then the resultant was maintained at about 300° C. to prepare a InP core.

### Step 2: Synthesis of InP/ZnS

1 mmol to 2 mmol of the InP core dispersed in toluene was mixed with 10 mmol to 50 mmol of trioctylamine and 1 mmol to 10 mmol of zinc oleate, and then were degassed at about 110° C. or more. Then, in a nitrogen atmosphere, 0.4 mmol to 1.6 mmol of trioctylphosphine-sulfide and 0.4 mmol to 1.6 mmol of zinc oleate were injected, and the resultant was reacted at about 320° C. or more to synthesize InP/ZnS.

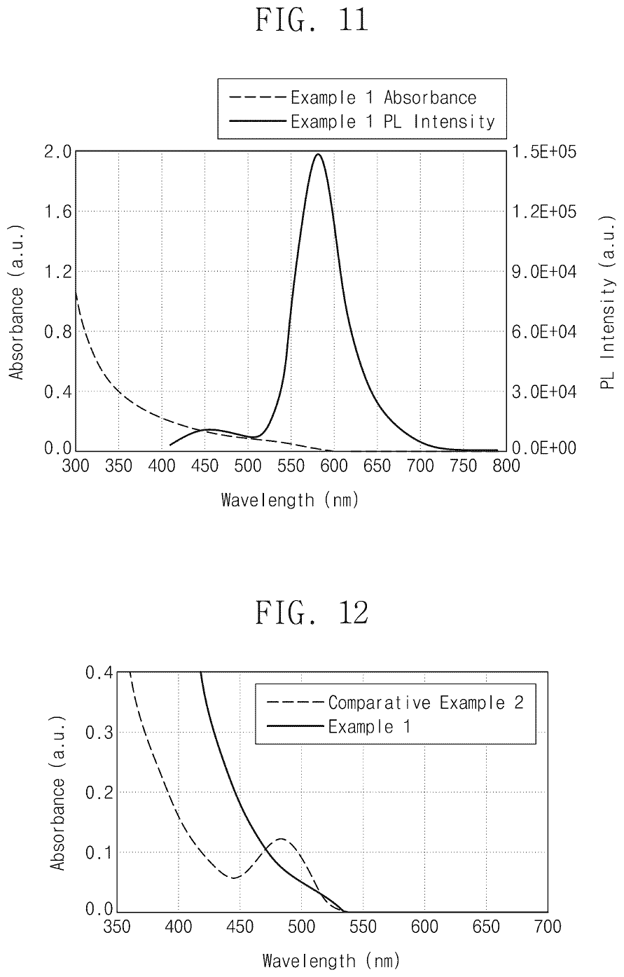

FIG. 11 shows absorbance and emission spectra of the quantum dots according to Example 1. FIG. 12 shows the absorbance spectra of the quantum dots according to Example 1 and Comparative Example 2. A vertical axis of the graph shown in FIG. 11 represents absorbance (a.u.) and light emission intensity (a.u.), and a horizontal axis represents an emission wavelength band. A vertical axis of the graph shown in FIG. 12 represents absorbance (a.u.) and a horizontal axis represents the emission wavelength band. FIG. 12 is simulation data of the absorbance of the quantum dots according to Example 1 and Comparative Example 2.

Referring to FIG. 11, it can be confirmed that the quantum dot according to Example 1 has, in about 560 nm to about 600 nm of a wavelength range, an emission peak exhibiting high emission intensity. The first emission peak may be caused by a band-edge emission. It can be confirmed that the quantum dots formed by the method for preparing the quantum dot according to one or more embodiments exhibits high emission intensity in about 560 nm to about 600 nm of a wavelength range. Therefore, the method for preparing the quantum dot according to one or more embodiments may provide a quantum dot having excellent or suitable emission properties due to the high emission intensity. In addition, as a wavelength becomes smaller in a blue light emission wavelength region of about 380 nm to about 450 nm, high absorbance is shown. Referring to FIGS. 11 and 12 together, as the quantum dots emit at the shorter wavelengths of the blue light region, an absorbance of the quantum dots according to Example 1 consistently increases. However, compared to the quantum dots according to Example 1, the quantum dots according to Comparative Example 2 exhibits a phenomenon in which there is a repeated rise and fall of the absorbance. It is due to the fact that InP in the quantum dots according to Comparative Example 2 have a Bohr radius of about 9 nm, and because the quantum dot according to Comparative Example 2 should have a particle size of about 2 nm to about 4 nm in order to emit light in visible light region, so the quantum dot is subject to strong quantum confinement effects. Compared to this, because the quantum dots according to Example 1 have the Bohr radius of about 4.5 nm, the quantum dots are subject to weak quantum confinement effects compared to the quantum dots of Comparative Example 2, and thus as the quantum dots emit light with a shorter wavelength in a blue light wavelength region, the absorbance consistently increases. Therefore, light absorption properties are excellent or suitable.

A maximum light emission wavelength, a full width at half maximum, and the average diameter of the cores according to Example 1 were compared to those of the cores according to Comparative Example 1, and the values are listed in Table 1. When the full width of half maximum is small, it means that color reproductivity has been improved.

TABLE 1

| | Maximum light | Full width at | Diameter |
|---|---|---|---|
| | emission wavelength | half maximum | of core |
| Cores according | 594 nm | 82 nm | 2.4 nm |
| to Comparative | | | |
| Example 1 | | | |
| Cores according | 583 nm | 64 nm | 3.9 nm |
| to Example 1 | | | |

Referring to Table 1, the maximum light emission wavelengths of the cores according to Example 1 and Comparative Example 1 are respectively about 583 nm and about 594 nm, which fall within the green light wavelength region. The cores according to Example 1 have a larger diameter by 1.625-fold than the cores according to Comparative Example 1. Without being bound by any particular theory, it is believed that as the cores mof the quantum dots increase in size (e.g., diameter), light absorption properties are improved. In addition, because the cores according to embodiments of the present disclosure have a substantially uniform size, compared to the cores according to Comparative Example 1, the full width at half maximum decreases, and thus color reproductivity is improved.

Weight absorption coefficients (mL/mg·cm) of the quantum dots according to Example 1 and Comparative Example 2 are listed in Table 2 to express absorbance performance. The higher the weight absorption coefficient, the better the absorbance performance of the quantum dots.

TABLE 2

| | Weight absorption coefficient |
|---|---|
| Comparative Example 2 | 250 (mL/mg · cm) |
| Example 1 | 816 (mL/mg · cm) |

Referring to Table 2 above, the quantum dots according to Example 1 have the larger weight absorption coefficient than the quantum dots according to Comparative Example 2 by about 3.3-fold. Without being bound by any particular theory, it is interpreted that because the Bohr radius of CuInGaS included in the cores of the quantum dots according to Example 1 is smaller than the Bohr radius of InP included in the cores of the quantum dots according to Comparative Example 2, the quantum confinement effects are less, and thus the absorbance performance is improved.

The method for preparing a quantum dot, according to one or more embodiments of the present disclosure, may prepare a quantum dot including a core containing a quaternary CuInGaS compound using a precursor containing gallium oleate, and indium oleate. In a related or comparable method for synthesizing a quantum dot, because a metal halide is used as a precursor, a chemical reaction rate is excessively (or substantially) high, and thus the core of the quantum dot has a small and non-uniform size. In contrast, in the cores prepared according to the method for preparing the quantum dots according to the present disclosure, precursors containing gallium oleate and indium oleate are used, and thus the cores may have relatively large and substantially uniform diameter, compared to the existing quantum dot. When the cores have a large diameter, light absorption properties may be excellent or suitable, and the cores may contribute to high quantum efficiency. When the size of the cores is substantially uniform, color reproductivity is excellent or suitable. By varying an average diameter of the cores in the above-described ranges, an emission wavelength of the quantum dots and/or semiconductor properties of the quantum dots, and/or the like may be variously changed.

The method for preparing quantum dots according to one or more embodiments includes providing the first precursor containing gallium oleate and the second precursor containing indium oleate, and thus may provide quantum dots that have, compared to related or comparable quantum dots, large (e.g., larger or relatively large) and substantially uniform sizes, thereby exhibiting improved color reproductivity and light absorption properties.

The quantum dots according to one or more embodiments have, compared to the related or comparable quantum dots, large and substantially uniform sizes, and thus may exhibit improved color reproductivity and light absorption properties.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Further, the use of “may” when describing embodiments of the present disclosure refers to “one or more embodiments of the present disclosure.”

The light emitting device, electronic apparatus or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the embodiments of the present disclosure have been described, it is understood that the present disclosure should not be limited to these embodiments, but one or more suitable changes and modifications can be made by one ordinary skilled in the art within the spirit and scope of the present disclosure as defined by the following claims and equivalents thereof.

What is claimed is:

1. A method for preparing a quantum dot, the method comprising:
supplying a first mixture comprising
a first precursor comprising gallium oleate,
a second precursor comprising indium oleate, and
a third precursor comprising a sulfur atom;
forming a second mixture by adding a first solvent to the first mixture; and
forming a fourth mixture comprising a core comprising a copper atom, an indium atom, a gallium atom, and a sulfur atom by adding a third mixture comprising copper to the second mixture.

2. The method of claim 1, wherein the core has a diameter of about 3 nm to about 6 nm.

3. The method of claim 1, wherein the first solvent comprises at least one selected from among 1-octadecene and trioctylamine.

4. The method of claim 1, further comprising reacting the fourth mixture at a first temperature for about 5 minutes to about 15 minutes,
wherein the first temperature is about 250° C. to about 350° C.

5. The method of claim 1, wherein, in the second mixture, a number of moles of gallium atoms is greater than a number of moles of indium atoms.

6. The method of claim 1, further comprising forming a first shell around the core by reacting the core with a fourth precursor containing zinc oleate and a fifth precursor containing a sulfur atom.

7. The method of claim 6, wherein:
a mass of gallium atoms is about 5 wt % to about 50 wt % with respect to a total mass of 100 wt % the quantum dot; and
a ratio of the mass of gallium atoms with respect to the mass of the quantum dot is greater than a ratio of a mass of indium atoms with respect to the mass of the quantum dot in the quantum dot.

8. The method of claim 6, wherein:
the first solvent comprises 1-octadecene and trioctylamine; and
the method further comprises degassing trioctylamine at 120° C. before the forming of the first shell.

9. The method of claim 6, wherein:
the forming of the first shell is performed at a second temperature for about 15 minutes to about 25 minutes; and
the second temperature is about 280° C. to about 350° C.

10. The method of claim 6, wherein a molar ratio of the fourth precursor to the fifth precursor is about 1:1.

11. The method of claim 6, wherein, in the forming of the first shell, the fourth precursor and the fifth precursor are each independently provided in an amount of about 0.4 mmol to about 1.6 mmol.

12. The method of claim 6, wherein the first shell has a thickness of about 0.5 nm to about 3 nm.

13. The method of claim 6, further comprising forming a second shell around the first shell by adding a first element precursor and a second element precursor to a first particle comprising the core and the first shell.

14. The method of claim 13, wherein the second shell comprises at least one selected from among ZnSe, ZnS, ZnTe, ZnO, ZnMg, ZnMgSe, ZnMgS, ZnMgAl, GaSe, GaTe, GaP, GaAs, GaSb, InAs, InSb, AlP, AlAs, AlSb, MnS, MnSe, MgS, and MgSe.

15. The method of claim 13, wherein the second shell has a thickness of about 0.5 nm to about 3 nm.

16. The method of claim 13, wherein a thickness of the second shell is greater than a thickness of the first shell.

17. A quantum dot comprising:
a core comprising a copper atom, an indium atom, a gallium atom, and a sulfur atom, and
a first shell around the core and comprising a zinc atom, and a sulfur atom,
wherein the core has a diameter of about 3 nm to about 6 nm.

18. The quantum dot of claim 17, wherein in the quantum dot:
a mass of gallium atoms is about 5 wt % to about 50 wt % with respect to a total mass of 100 wt % of the quantum dot; and
a ratio of the mass of gallium atoms with respect to the mass of the quantum dot is greater than a ratio of a mass of indium atoms with respect to the mass of the quantum dot.

19. The quantum dot of claim 17, further comprising:
a second shell around the first shell and comprising at least one selected from among ZnSe, ZnS, ZnTe, ZnO, ZnMg, ZnMgSe, ZnMgS, ZnMgAl, GaSe, GaTe, GaP, GaAs, GaSb, InAs, InSb, AlP, AlAs, AlSb, MnS, MnSe, MgS, and MgSe.

20. The quantum dot of claim 19, wherein a thickness of the second shell is greater than a thickness of the first shell.
